(19) United States
(12) Patent Application Publication
(10) Pub. No.: US 2015/0013220 A1
(43) Pub. Date: Jan. 15, 2015

(54) Save-A-Tree-System Apparatus

(71) Applicant: Thomas Ross, Midland, TX (US)

(72) Inventor: Samuel Ross, Jonestown, TX (US)

(21) Appl. No.: 13/937,668

(22) Filed: Jul. 9, 2013

(51) Int. Cl. A01G 25/06

(52) U.S. Cl. CPC A01G 25/06
USPC 47/48.5

(57) ABSTRACT

An apparatus and system for irrigation is disclosed. The Save-A-Tree-System Apparatus is an apparatus for sub-surface irrigation which uses a rigid or semi-rigid tube with a plurality of fluid emitters disposed in the tube, which is buried in order to deliver irrigation to the root-zone of plants, which can be connected in series to efficiently direct irrigation to multiple locals, and which has an internal reservoir for the application of fertilizer, pesticide, fungicide, or the like, to an individual location to supplement system-wide treatment. Irrigation water or treated water is delivered from a source to the Save-A-Tree-System Apparatus via a connecting hose. A pressure regulator, filter and/or directional flow check valve may also be installed between the source and a Save-A-Tree-System Apparatus as needed to control the irrigation water that is delivered to the apparatus. The Save-A-Tree-System Apparatus may also simultaneously provide both aboveground and sub-surface irrigation and aeration.

### CROSS-REFERENCE TO RELATED APPLICATIONS

This application claims benefit of U.S. Provisional Patent Application No. 61/669,959 which was filed on Jul. 10, 2012, and which is incorporated herein in its entirety.

### STATEMENT REGARDING FEDERALLY SPONSORED RESEARCH OR DEVELOPMENT

Not Applicable

REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of the Invention

The present invention is in the technical field of irrigation systems. More particularly, the preferred embodiments of the present invention relate generally to sub-surface irrigation systems which directly irrigate underground. More particularly, the preferred embodiments of the present invention relate generally to sub-surface irrigation systems which use one or more rigid or semi-rigid stakes to deliver irrigation underground to the root zone of plants, with each stake delivering irrigation to one or more plants. Furthermore, the preferred embodiments of the present invention relate generally to sub-surface irrigation systems which allows for the system-wide release of irrigation water or mixtures of liquid fertilizer, pesticide, fungicide, aerated water or the like, into the sub-surface root zone. Moreover, the preferred embodiments of the present invention relate generally to sub-surface irrigation systems which allows for the selective application of irrigation water or mixtures of liquid fertilizer, pesticide, fungicide, aerated water or the like, into the sub-surface root zone of a particular single plant, based on the specific needs of the single plant, in addition to the system-wide release of irrigation water or mixtures of liquid fertilizer, pesticide, fungicide, aerated water, or the like, into the sub-surface root zone. Additionally, the preferred embodiments of the present invention relate generally to a sub-surface irrigation system, which also has the ability to provide aboveground irrigation.

2. Description of the Related Art

The broad concept of a sub-surface irrigation system is known. These inventions usually involve buried hoses or irrigation channels. Many of these systems are installed horizontally at one level and do not provide irrigation at various depths even though the root zone of plants are often at variable depths.

It is also known to construct a sub-surface irrigation system, which uses rigid stakes to deliver sub-surface irrigation to the root zone of plants. However, these apparatuses do not allow for internal reservoirs which can provide specific treatment, such as fertilizer, pesticide, fungicide, aerated water, or the like, to individual plants or trees.

It is also known to construct a sub-surface irrigation system, which uses a plurality of openings for fluid delivery to the root zone of plants. However, these existing inventions have openings which do not compensate for differing underground conditions and are susceptible to excessive erosion when irrigation fluid at too high of a pressure is applied underground. Additionally, if the water pressure is too low, the surrounding ground may prevent the release of fluid.

It is also known to construct a sub-surface irrigation systems which allows for the system-wide release of irrigation water or mixtures of liquid fertilizer, pesticide, fungicide, aerated water or the like, into the sub-surface root zone. However, the existing inventions do not allow for individualized treatment in addition to system-wide treatment.

### SUMMARY OF THE INVENTION

The broad embodiments of the present invention relates to an improvement of an apparatus for sub-surface irrigation. The Save-A-Tree-System Apparatus is an apparatus for sub-surface irrigation which uses a rigid or semi-rigid tube with a plurality of fluid emitters disposed in the tube, which is buried or inserted into the ground in order to deliver irrigation to the root-zone of plants, which can be connected in series to efficiently direct irrigation to multiple locals, and which has an internal reservoir for the application of fertilizer, pesticide, fungicide, aerated water, or the like, to an individual location to supplement system-wide treatment.

In the most preferred embodiments, the Save-A-Tree-System Apparatus comprises a tube, a vacuum release valve, an entrance port, an exit port, a plurality of pressure compensating emitters, which are mounted in the tube, an internal reservoir and an end plug. The tube is rigid or semi-rigid and hollow in order to accommodate irrigation fluid within the tube and is suitable for burial underground. The vacuum release value allows for air to enter the system when it is not under pressure and may provide aeration to the root zone of plants while in the configuration which allows for air to enter the system. The vacuum release value is aboveground and removable in order to allow for internal access to the Save-A-Tree-System Apparatus so that fertilizer, pesticide, fungicide, or the like, may be added to the internal reservoir. The vacuum release valve may also be replaced with a fluid emitter to provide aboveground irrigation. A connecting conduit, which may be a regular garden hose or a rigid pipe, is connected to the entrance port to allow irrigation fluid from a source to enter the Save-A-Tree-System Apparatus through the entrance port. The exit port allows for excess irrigation fluid to exit a Save-A-Tree-System Apparatus. A connecting conduit may be connected to the exit port to enable another Save-A-Tree-System Apparatus to be connected in series and to allow excess irrigation fluid to flow from an upstream Save-A-Tree-System Apparatus through the exit port and a connecting conduit and into the next downstream Save-A-Tree-System Apparatus. The exit port may also be plugged at the last Save-A-Tree-System Apparatus in a series to prevent unwanted water loss. The pressure compensating emitters are mounted in the tube and allow for the measured injection of irrigation fluid into the ground surrounding the buried Save-A-Tree-System Apparatus. The internal reservoir comprises the space in the bottom portion of the tube between the bottommost pressure compensating emitter and the end plug at the bottom of the tube and may receive fertilizer, pesticide, fungicide, or the like. The end plug closes off the bottom of the Save-A-Tree-System Apparatus. In further detail, the Save-A-Tree-System Apparatus is buried near the plant or tree, which is to be irrigated, such that the pressure compensating emitters are substantially near the root zone of the plant or tree being irrigated. Irrigation water or treated irrigation water is delivered from a source to the Save-A-Tree-System Apparatus via a connecting conduit. If a single location is to be irrigated, a single connecting conduit is used to supply irrigation water or treated irrigation water to the Save-A-Tree-System Apparatus and the exit port is plugged to prevent unwanted fluid loss. If several locations are to be irrigated, a Save-A-Tree-System Apparatus is bured at each location to be irrigated, and the Save-A-Tree-System Apparatuses are connected in series using connecting conduits. For the system-wide treatment of irrigation water, various modules may be connected in series before the first Save-A-Tree-System Apparatus in the series which inject liquid fertilizer, pesticide, fungicide, aerated water, or the like, into the irrigation water and deliver treated irrigation water to the root zone of plants through each Save-A-Tree-System Apparatus. If individual plants have particular irrigation needs, which differ from other plants being irrigated by the system, the localized treatment may be added to the internal reservoir of the Save-A-Tree-System Apparatus located at the plant with the particular needs.

### BRIEF DESCRIPTION OF THE DRAWING

Illustrative and preferred embodiments of the present invention are shown in the accompanying drawings in which:

FIG. 1 is a perspective view of the present invention;

FIG. 2 is a side view of the present invention of FIG. 1;

FIG. 3 is a top view of the present invention of FIG. 1;

FIG. 4 is a cross-sectional side view of the present invention of FIG. 1;

FIG. 5 is a cross-sectional side view of the present invention of FIG. 1 installed in the ground;

FIG. 6 is a cross-sectional side view of the present invention of FIG. 1 installed in a connected series in the ground;

FIG. 7 is a perspective view of another embodiment of the present invention;

FIG. 8 is a side view of the present invention of FIG. 7;

FIG. 9 is a top view of the present invention of FIG. 7;

FIG. 10 is a cross-sectional side view of the present invention of FIG. 7;

FIG. 11 is a cross-sectional side view of the present invention of FIG. 7 with a series of in-line modules installed;

FIG. 12 is a top view of the present invention of FIG. 7 with a series of in-line modules installed; and

FIG. 13 is a cross-sectional side view of the present invention of FIG. 7 installed in the ground.

### DETAILED DESCRIPTION OF THE PREFERRED EMBODIMENTS

For the purpose of illustration, the present invention is shown in the preferred embodiments of an apparatus for sub-surface irrigation which uses a rigid or semi-rigid tube with a plurality of pressure-compensating emitters disposed in the tube, which is buried or inserted into the ground in order to deliver irrigation to the root-zone of plants, and an apparatus for sub-surface irrigation which uses a rigid or semi-rigid tube with a plurality of openings which is buried or inserted into the ground in order to deliver irrigation to the root-zone of plants. Each of these embodiments has an internal reservoir for the application of fertilizer, pesticide, fungicide, or the like, to an individual location. Furthermore, each of these embodiments may be fitted with an aboveground emitter, which delivers irrigation above the ground surface in addition to sub-surface irrigation. Each of these embodiments may also be fitted with an aboveground vacuum release valve to allow air to enter the system when the system is not pressurized and in order to provide aeration to the root zone of plants. The vacuum release value is aboveground and removable in order to allow for internal access to the Save-A-Tree-System Apparatus so that fertilizer, pesticide, fungicide, or the like, may be added to the internal reservoir. The vacuum release valve may also be replaced with a fluid emitter to provide aboveground irrigation. Additionally, each of these embodiments may be used as an individual apparatus to provide irrigation to a single location or as a plurality apparatuses, which are connected in a series, in order to provide irrigation at several locations. When used in a series, each of these embodiments allow for modules to be connected to the system which allow for the irrigation water to be mixed with liquid fertilizer, aerated water, pesticide, fungicide, or the like, for system-wide treatment. These embodiments are not intended to limit the scope of the present invention.

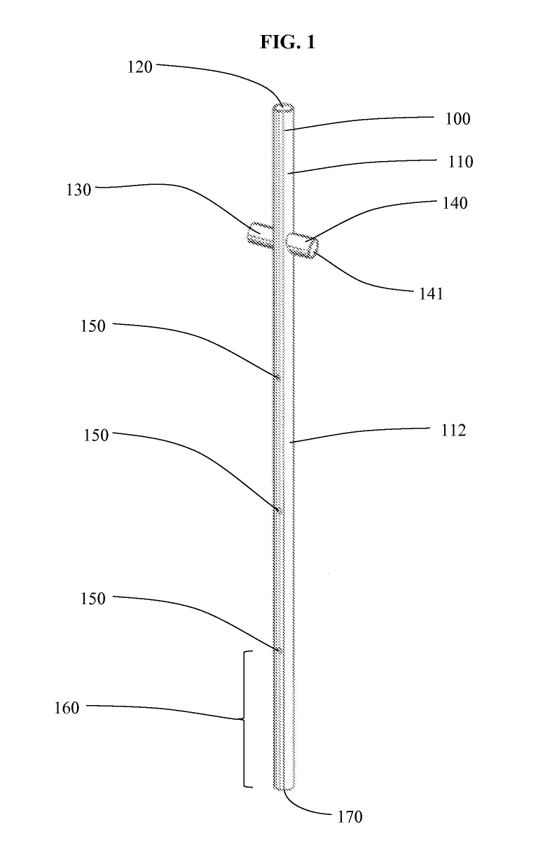

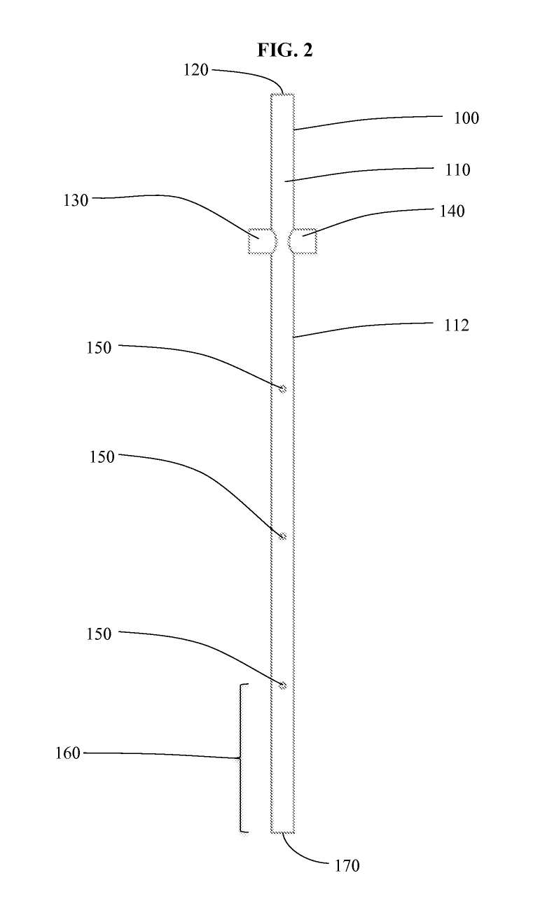

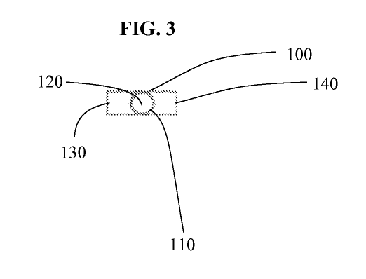

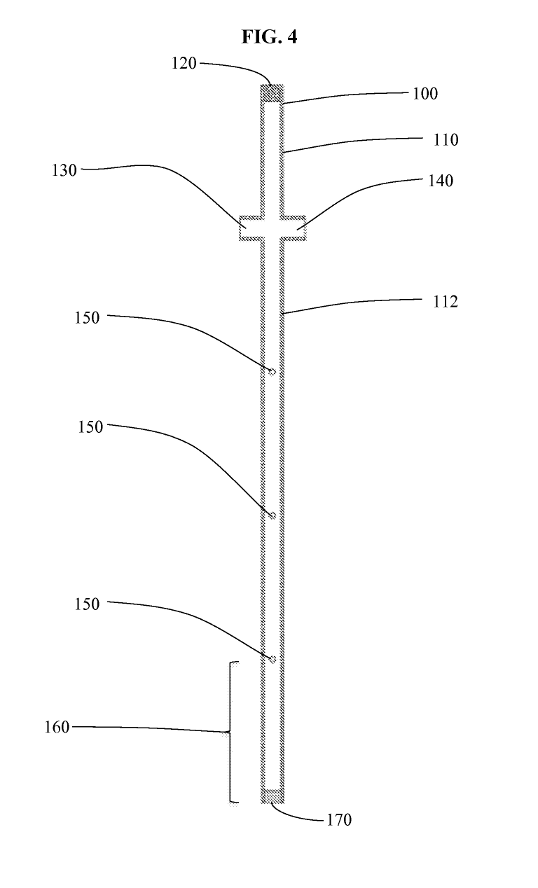

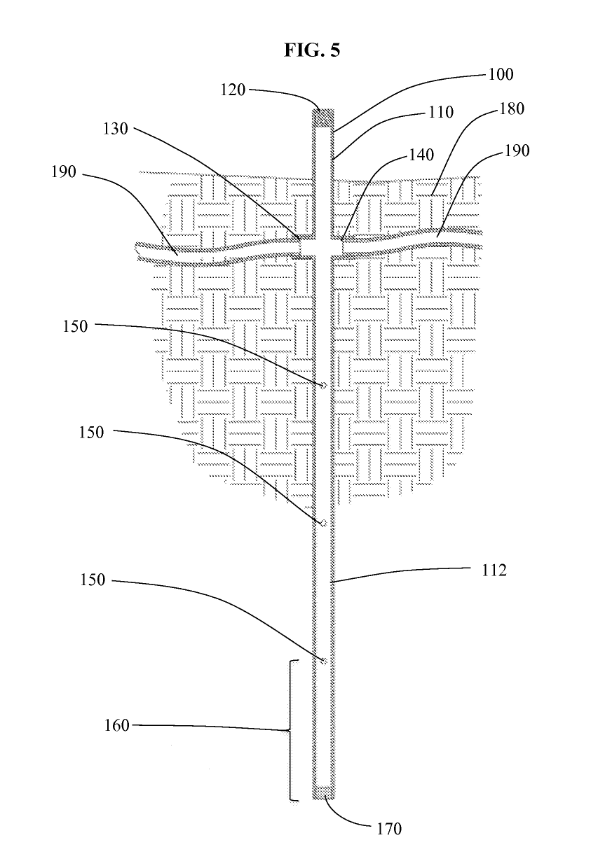

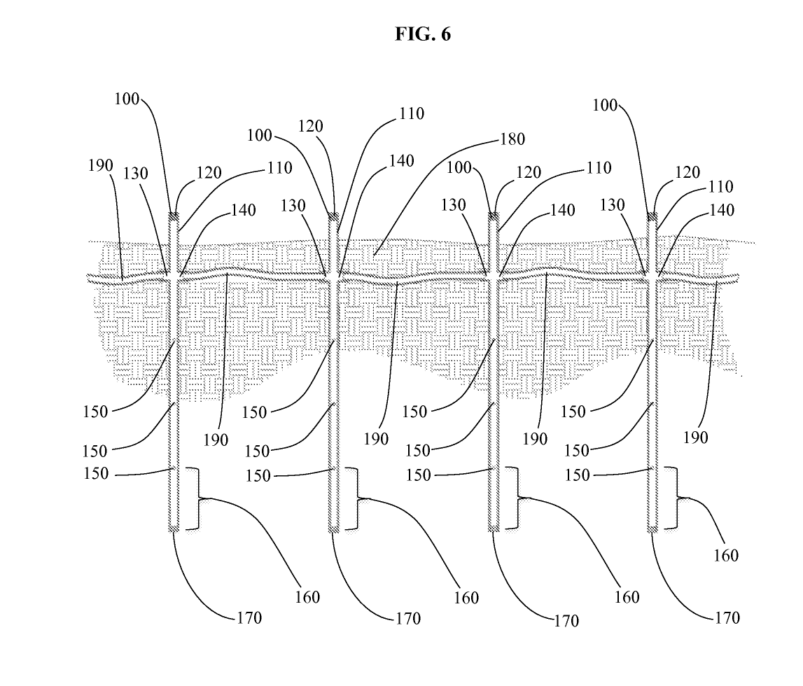

Referring now to the most preferred embodiment of the invention, in FIG. 1, FIG. 2, FIG. 3, FIG. 4, FIG. 5 and FIG. 6, a Save-A-Tree-System Apparatus 100 is illustrated. FIG. 1 shows a perspective view of a Save-A-Tree-System Apparatus 100. FIG. 2 illustrates a side view of a Save-A-Tree-System Apparatus 100. FIG. 3 depicts a top view of a Save-A-Tree-System Apparatus 100. FIG. 4 demonstrates a cross-sectional side view of a Save-A-Tree-System Apparatus 100. FIG. 5 illustrates a cross-sectional side view of a Save-A-Tree-System Apparatus 100 mounted in the ground 180. FIG. 6 illustrates a cross-sectional side view of a series of Save-A-Tree-System Apparatuses 100 connected with connecting conduits 190 and mounted in the ground 180.

In further detail, still referring to the invention of FIG. 1, FIG. 2, FIG. 3, FIG. 4, FIG. 5, and FIG. 6, the Save-A-Tree-System Apparatus 100 comprises a tube 110, a vacuum release valve 120, an entrance port 130, an exit port 140, a plurality of pressure compensating emitters 150, which are mounted in the tube 110, an internal reservoir 160 and an end plug 170. Two or more Save-A-Tree-System Apparatuses 100 may be connected together, or in a series, with connecting conduits 190. The tube 110 is rigid or semi-rigid with an outer wall 112, is hollow in order to accommodate irrigation fluid within the tube 110 and is suitable for burial underground. The vacuum release valve 120 is connected to the top of the tube 110 and sits above the ground 180 for easy access and adjustment when the Save-A-Tree-System Apparatus 100 is installed in the ground 180. The vacuum release value 120 allows for air to enter the system when it is not under pressure, thereby providing aeration to the root zone of plants, and is removable in order to allow for internal access to the Save-A-Tree-System Apparatus 100 so that fertilizer, pesticide, fungicide, or the like, may be added to the internal reservoir 160. The vacuum release valve 120 may also be replaced with a pressure compensating emitter 150 to provide aboveground irrigation. The entrance port 130 depends from the tube 110 and is perpendicular to the tube 110 and allows for irrigation fluid to enter into the Save-A-Tree-System Apparatus 100. A connecting conduit 190 is connected to the entrance port 130 to allow irrigation fluid from a source to enter the Save-A-Tree-System Apparatus 100 through the entrance port 130. The exit port 140 depends from the tube 110 and is perpendicular to the tube 110 but on the opposite side of the tube 110 from the entrance port 130. The exit port 140 allows for excess irrigation fluid to exit a Save-A-Tree-System Apparatus 100. A connecting conduit 190 may be connected to the exit port 140 to enable another Save-A-Tree-System Apparatus 100 to be connected in series and to allow excess irrigation fluid to flow from an upstream Save-A-Tree-System Apparatus 100 through the exit port 140 and a connecting conduit 190 and into the next downstream Save-A-Tree-System Apparatus 100. The exit port 140 may also be plugged by an exit port cap 141 on the last Save-A-Tree-System Apparatus 100 in a series to prevent unwanted water loss. A regular garden hose may also be connected to the entrance port 130 and the exit port 140 may be plugged to allow for the use of one Save-A-Tree-System Apparatus 100 at a single location. The pressure compensating emitters 150 are mounted in the tube 110 and allow for the measured injection of irrigation fluid into the ground 180 surrounding the buried Save-A-Tree-System Apparatus 100. The pressure compensating emitters 150 stabilize the pressure of irrigation fluid being emitted by the Save-A-Tree-System Apparatus 100 in order to compensate for pressure variations that arise because of the differing underground depths of each pressure compensating emitter 150 as well as the variation in soil composition and density at each pressure compensating emitters 150. The pressure compensating emitters 150 significantly reduce water waste from irrigation due to ground 180 variations at the root zone of the plants being irrigated. The internal reservoir 160 comprises the space in the bottom portion of the tube 110 between the bottommost pressure compensating emitter 150 and the end plug 170 at the bottom of the tube 110. The end plug 170 closes off the bottom of the Save-A-Tree-System Apparatus 100.

In further detail, still referring to the invention of FIG. 1, FIG. 2, FIG. 3, FIG. 4, FIG. 5, and FIG. 6, to provide irrigation, the Save-A-Tree-System Apparatus 100 is buried near the plant or tree which is to be irrigated such that the pressure compensating emitters 150 are substantially near the root zone of the plant or tree being irrigated. Irrigation water or treated irrigation water is delivered from a source to the Save-A-Tree-System Apparatus 100 via a connecting conduit 190. If a single location is to be irrigated, a single connecting conduit is used to supply irrigation water or treated irrigation water to the Save-A-Tree-System Apparatus 100 and the exit port 140 is plugged to prevent unwanted fluid loss. If several locations are to be irrigated, a Save-A-Tree-System Apparatus 100 is buried at each location to be irrigated, and the Save-A-Tree-System Apparatuses 100 are connected in series using connecting conduits 190 which connect the exit port 140 of the preceding Save-A-Tree-System Apparatus 100 to the entrance port 130 of the next Save-A-Tree-System Apparatus 100 in the series. The exit port 140 of the last Save-A-Tree-System Apparatus 100 in the series may be plugged to present unwanted water loss through that exit port 140. For the system-wide treatment of irrigation water, various modules may be connected in series before the first Save-A-Tree-System Apparatus 100 in the series which inject liquid fertilizer, pesticide, fungicide, aerated water, or the like, into the irrigation water and deliver treated irrigation water to the root zone of plants through each Save-A-Tree-System Apparatus 100. If individual plants have particular irrigation needs, which differ from other plants being irrigated by the system, such as special fertilizer requirements or particular fungicide treatment, the localized treatment may be added to the internal reservoir 160 of the Save-A-Tree-System Apparatus 100 located at the plant with the particular needs. A pressure regulator, filter and/or directional flow check valve may also be installed between the source and a Save-A-Tree-System Apparatus 100 (or the first Save-A-Tree-System Apparatus 100 in a series) as needed to control the irrigation water that is delivered to the Save-A-Tree-System Apparatus(es) 100.

The construction details of the invention as shown in FIG. 1, FIG. 2, FIG. 3, FIG. 4, FIG. 5 and FIG. 6, are that the Save-A-Tree-System Apparatus 100 comprises a tube 110, a vacuum release valve 120, an entrance port 130, an exit port 140, a plurality of pressure compensating emitters 150, which are mounted in the tube 110, an internal reservoir 160 and an end plug 170, in which two or more Save-A-Tree-System Apparatuses 100 may be connected together, or in a series, with connecting conduits 190. The tube 110 is comprised of a weather resistant material which is well suited for installation underground and which is capable of withstanding pressurized water, such as plastic, rubber, metal, powder-coated metal, composite materials or the like, or a combination thereof. The vacuum release valve 120 is comprised of a valve assembly which is further comprised of one or more pressure-resistant materials, such as metal, plastic or the like, or a combination thereof. The entrance port 130 comprises a weather resistant material which is well suited for installation underground and which is capable of withstanding pressurized water, such as plastic, rubber, metal, powder-coated metal, composite materials or the like, or a combination thereof, and may be comprised as a singular construction with the tube 110 and/or exit port 140. The exit port 140 comprises a weather resistant material which is well suited for installation underground and which is capable of withstanding pressurized water, such as plastic, rubber, metal, powder-coated metal, composite materials or the like, or a combination thereof, and may be comprised as a singular construction with the tube 110 and/or entrance port 130. The pressure compensating emitters 150 are self-contained constructions, which regulate the emission of irrigation water so that each emitter discharges substantially equivalent amounts of fluid, and are comprised of one or more materials, such as metal, plastic, silicone powder-coated metal, composite materials or the like, or a combination thereof, and are mounted within the tube 110 in such a way that irrigation water is emitted exterior to the tube 110. The internal reservoir 160 comprises the space in the bottom portion of the tube 110 between the bottommost pressure compensating emitter 150 and the end plug 170 at the bottom of the tube 110. The end plug 170 closes off the bottom of the Save-A-Tree-System Apparatus 100 and comprises a weather resistant material which is well suited for installation underground and which is capable of withstanding pressurized water, such as plastic, rubber, metal, powder-coated metal, composite materials or the like, or a combination thereof.

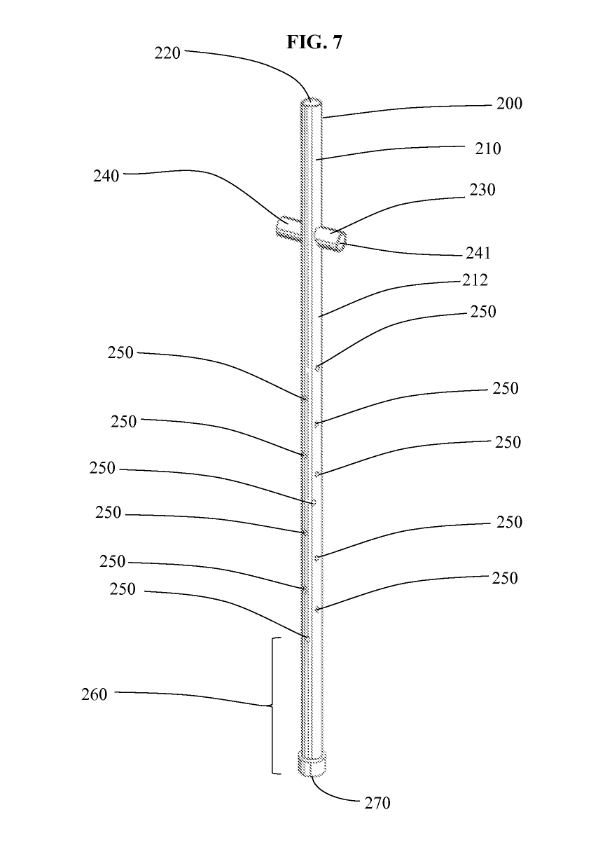

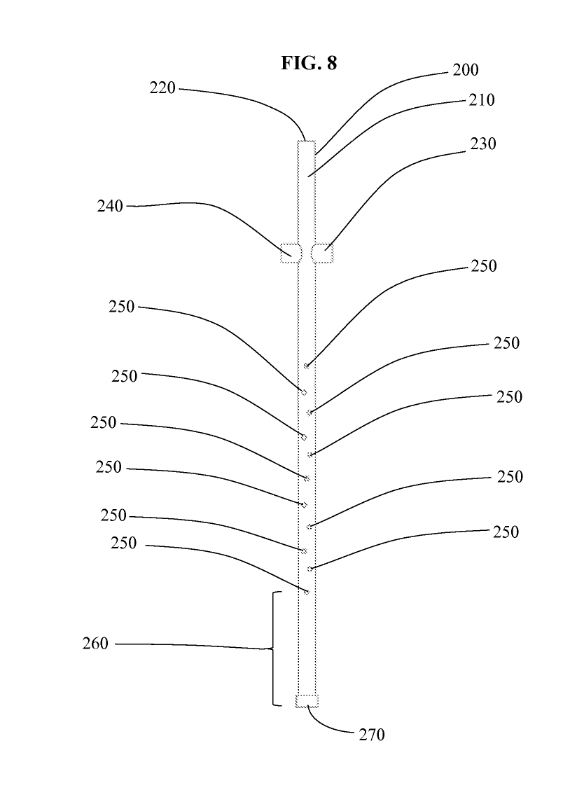

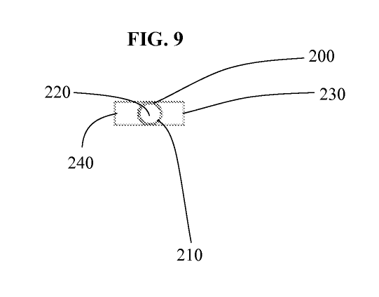

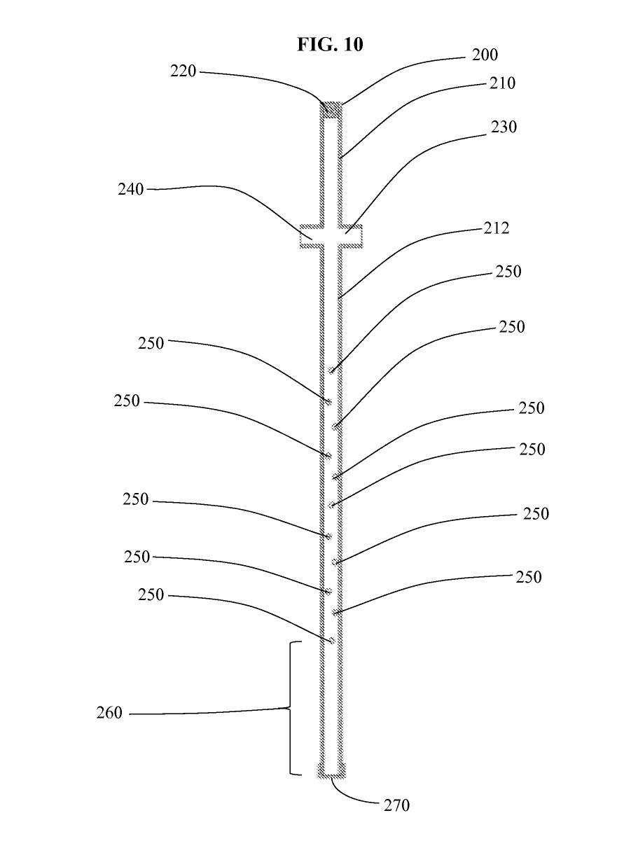

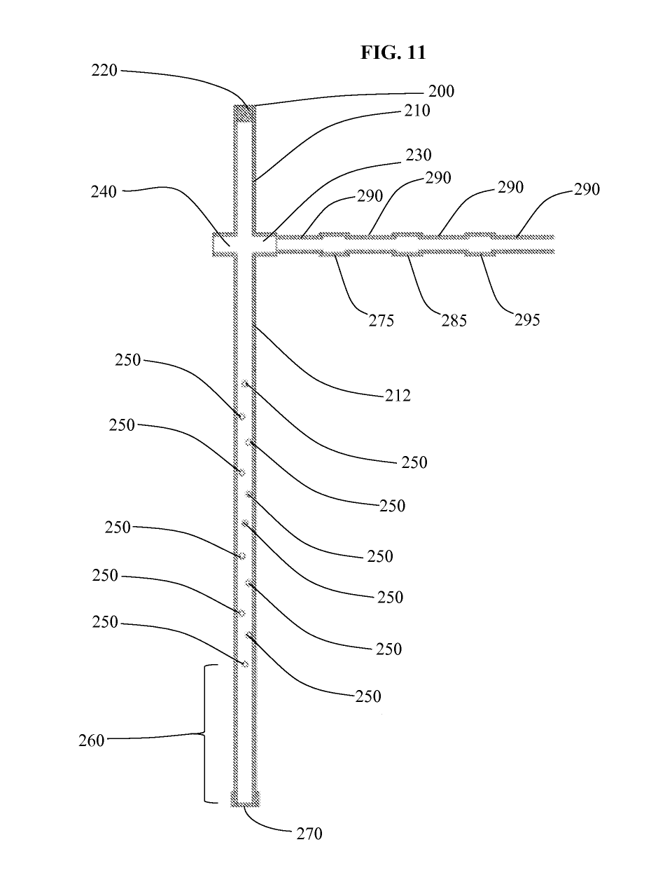

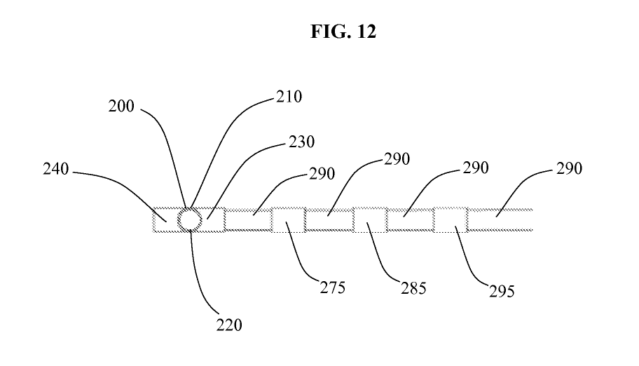

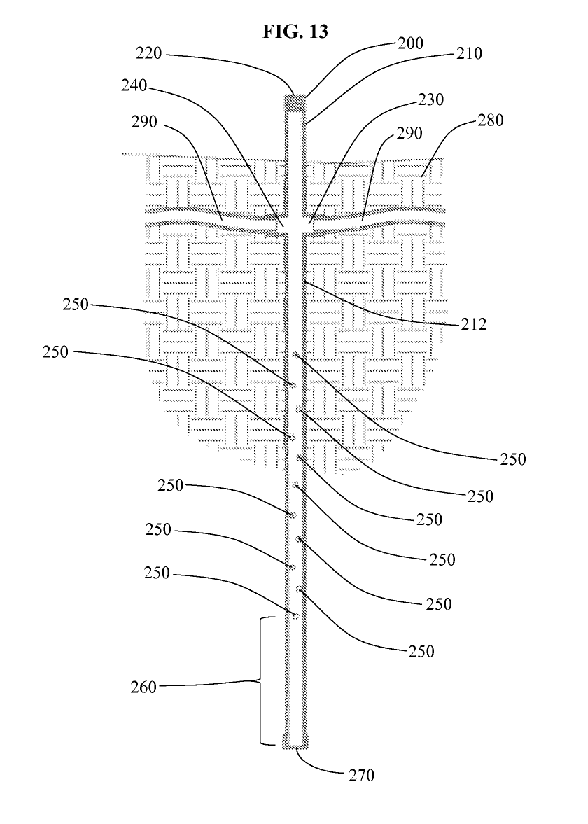

Referring now to another preferred embodiment of the invention, in FIG. 7, FIG. 8, FIG. 9, FIG. 10, FIG. 11, FIG. 12 and FIG. 13, a Save-A-Tree-System Apparatus 200 is illustrated. FIG. 7 shows a perspective view of a Save-A-Tree-System Apparatus 200. FIG. 8 illustrates a side view of a Save-A-Tree-System Apparatus 200. FIG. 9 depicts a top view of a Save-A-Tree-System Apparatus 200. FIG. 10 demonstrates a cross-sectional side view of a Save-A-Tree-System Apparatus 200. FIG. 11 shows a cross-sectional side view of a Save-A-Tree-System Apparatus 200 installed with a directional flow check valve 295, a filter 285 and a pressure regulator 275 installed in a series before the Save-A-Tree-System Apparatus 200 and connected with connecting conduits 190. FIG. 12 depicts a top view of a Save-A-Tree-System Apparatus 200 installed with a directional flow check valve 295, a filter 285 and a pressure regulator 275 installed in a series before the Save-A-Tree-System Apparatus 200 and connected with connecting conduits 290. FIG. 13 illustrates a cross-sectional side view of a Save-A-Tree-System Apparatus 200 mounted in the ground 280.

In further detail, still referring to the invention of FIG. 7, FIG. 8, FIG. 9, FIG. 10, FIG. 11, FIG. 12 and FIG. 13, the Save-A-Tree-System Apparatus 200 comprises a tube 210, a vacuum release valve 220, an entrance port 230, an exit port 240, a plurality of free flow emitters 250, which may be holes in the tube 210, an internal reservoir 260 and an adjustable end cap 170. Two or more Save-A-Tree-System Apparatuses 200 may be connected together, or in a series, with connecting conduits 290. The tube 210 is rigid or semi-rigid with an outer wall 212, is hollow in order to accommodate irrigation fluid within the tube 210 and is suitable for burial underground. The vacuum release valve 220 is connected to the top of the tube 210 and sits above the ground 280 for easy access and adjustment when the Save-A-Tree-System Apparatus 200 is installed in the ground 280. The vacuum release value 220 allows for air to enter the system when it is not under pressure, thereby providing aeration to the root zone of plants, and is removable in order to allow for internal access to the Save-A-Tree-System Apparatus 200 so that fertilizer, pesticide, fungicide, or the like, may be added to the internal reservoir 260. The vacuum release valve 220 may also be replaced with a free flow emitter 250 to provide aboveground irrigation. The entrance port 230 depends from the tube 210 and is perpendicular to the tube 210 and allows for irrigation fluid to enter into the Save-A-Tree-System Apparatus 200. A connecting conduit 290 is connected to the entrance port 230 to allow irrigation fluid from a source to enter the Save-A-Tree-System Apparatus 200 through the entrance port 230. The exit port 240 depends from the tube 210 and is perpendicular to the tube 210 but on the opposite side of the tube 210 from the entrance port 230. The exit port 240 allows for excess irrigation fluid to exit a Save-A-Tree-System Apparatus 200. A connecting conduit 290 may be connected to the exit port 240 to enable another Save-A-Tree-System Apparatus 200 to be connected in series and to allow excess irrigation fluid to flow from an upstream Save-A-Tree-System Apparatus 200 through the exit port 240 and a connecting conduit 290 and into the next dowstream Save-A-Tree-System Apparatus 200. The exit port 240 may also be plugged by an exit port cap 241 on the last Save-A-Tree-System Apparatus 200 in a series to prevent unwanted water loss. A regular garden hose may also be connected to the entrance port 230 and the exit port 240 may be plugged to allow for the use of one Save-A-Tree-System Apparatus 200 at a single location. The free flow emitters 250 are holes in the tube 210 and allow for irrigation fluid to flow into the ground 280 surrounding the buried Save-A-Tree-System Apparatus 200. The internal reservoir 260 comprises the space in the bottom portion of the tube 210 between the bottommost free flow emitter 250 and the adjustable end cap 270 at the bottom of the tube 210. The adjustable end cap 270 closes off the bottom of the Save-A-Tree-System Apparatus 200, and may be adjusted to control the size of the internal reservoir 260.

In further detail, still referring to the invention of FIG. 7, FIG. 8, FIG. 9, FIG. 10, FIG. 11, FIG. 12 and FIG. 13, to provide irrigation, the Save-A-Tree-System Apparatus 200 is buried near the plant or tree which is to be irrigated such that the free flow emitters 250 are substantially near the root zone of the plant or tree being irrigated. Irrigation water or treated irrigation water is delivered from a source to the Save-A-Tree-System Apparatus 200 via a connecting conduit 290. If a single location is to be irrigated, a single connecting conduit is used to supply irrigation water or treated irrigation water to the Save-A-Tree-System Apparatus 200 and the exit port 240 is plugged to prevent unwanted fluid loss. If several locations are to be irrigated, a Save-A-Tree-System Apparatus 200 is buried at each location to be irrigated, and the Save-A-Tree-System Apparatuses 200 are connected in series using connecting conduits 290 which connect the exit port 240 of the preceding Save-A-Tree-System Apparatus 200 to the entrance port 230 of the next Save-A-Tree System Apparatus 200 in the series. The exit port 240 of the last Save-A-Tree-System Apparatus 200 in the series may be plugged to present unwanted water loss through that exit port 240. For the system-wide treatment of irrigation water, various modules may be connected in series before the first Save-A-Tree-System Apparatus 200 in the series which inject liquid fertilizer, pesticide, fungicide, aerated water, or the like, into the irrigation water and deliver treated irrigation water to the root zone of plants through each Save-A-Tree-System Apparatus 200. If individual plants have particular irrigation needs, which differ from other plants being irrigated by the system, such as special fertilizer requirements or particular fungicide treatment, the localized treatment may be added to the internal reservoir 260 of the Save-A-Tree-System Apparatus 200 located at the plant with the particular needs. A pressure regulator 275, filter 285 and/or directional flow check valve 295 may also be installed between the source and a Save-A-Tree-System Apparatus 200 (or the first Save-A-Tree-System Apparatus 200 in a series) as needed to control the irrigation water that is delivered to the Save-A-Tree-System Apparatus(es) 200.

The construction details of the invention as shown in of FIG. 7, FIG. 8, FIG. 9, FIG. 10, FIG. 11, FIG. 12 and FIG. 13, are that the Save-A-Tree-System Apparatus 200 comprises a tube 210, a vacuum release valve 220, an entrance port 230, an exit port 240, a plurality of free flow emitters 250, which are holes in the tube 210, an internal reservoir 260 and an adjustable end cap 270, in which two or more Save-A-Tree-System Apparatuses 200 may be connected together, or in a series, with connecting conduits 290. The tube 210 is comprised of a weather resistant material which is well suited for installation underground and which is capable of withstanding pressurized water, such as plastic, rubber, metal, powder-coated metal, composite materials or the like, or a combination thereof. The vacuum release valve 220 is comprised of a valve assembly which is further comprised of one or more pressure-resistant materials, such as metal, plastic or the like, or a combination thereof. The entrance port 230 comprises a weather resistant material which is well suited for installation underground and which is capable of withstanding pressurized water, such as plastic, rubber, metal, powder-coated metal, composite materials or the like, or a combination thereof, and may be comprised as a singular construction with the tube 210 and/or exit port 240. The exit port 240 comprises a weather resistant material which is well suited for installation underground and which is capable of withstanding pressurized water, such as plastic, rubber, metal, powder-coated metal, composite materials or the like, or a combination thereof, and may be comprised as a singular construction with the tube 210 and/or entrance port 230. The free flow emitters 250 are holes in the tube 210 which allow irrigation water to be emitted exterior to the tube 210. The internal reservoir 260 comprises the space in the bottom portion of the tube 210 between the bottommost pressure compensating emitter 250 and the end plug 270 at the bottom of the tube 210. The adjustable end cap 270 closes off the bottom of the Save-A-Tree-System Apparatus 200 and comprises a weather resistant material which is well suited for installation underground and which is capable of withstanding pressurized water, such as plastic, rubber, metal, powder-coated metal, composite materials or the like, or a combination thereof. The adjustable end cap 270 may be adjusted to control the size of the internal reservoir 260.

The advantages of the present invention include, without limitation, that it provides a efficient irrigation directly to the root zone of plants being irrigated, it reduces water waste that can be experienced with other forms of irrigation, and allows for system-wide treatment of irrigation water as well as individualized treatment for specific plants which require particular treatment which is in addition to system-wide treatment. Therefore, the system may be customized to provide individual treatment of different types of plants or trees. Additionally, the most preferred embodiment also prevents excess erosion by controlling the pressure of the irrigation water that is released underground by using pressure compensating emitters. Furthermore, the present invention has the advantage of protecting plants and trees from drought by delivering irrigation water underground where it is less susceptible to evaporation during hot or dry weather. Moreover, the use of vacuum release valves prevent the system from locking up when not under pressure by allowing air to enter the system and provide aeration to the root zone of individual plants. The Save-A-Tree-System Apparatus also has the ability to supplement sub-surface irrigation with aboveground irrigation in times when evaporation is not an issue.

In broad embodiment, the present invention is an improvement of an apparatus for sub-surface irrigation. The Save-A-Tree-System Apparatus is an apparatus for sub-surface irrigation which uses a rigid or semi-rigid tube with a plurality of fluid emitters disposed in the tube, which is buried or inserted into the ground in order to deliver irrigation to the root-zone of plants, which can be connected in series to efficiently direct irrigation to multiple locals, and which has an internal reservoir for the application of fertilizer, pesticide, fungicide, or the like, to an individual location to supplement system-wide treatment.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiments, methods, and examples, but by all embodiments and methods that are within the scope and spirit of the invention as claimed.

What is claimed is:

1. An apparatus for irrigation, said apparatus comprising: a tube, said tube comprising a rigid outer wall, which is suitable for burial underground, and a hollow interior, which is capable of receiving pressurized irrigation fluid and which is surrounded by said rigid outer wall; an entrance port, said entrance port depending from said tube, said entrance port being suitable for connecting to a connecting conduit, such as a garden hose or a pipe, in order to allow irrigation fluid from a source to enter said tube through said entrance port; an exit port, said exit port depending from said tube, said exit port being suitable for connecting to a connecting conduit, such as a garden hose or a pipe, in order to allow excess irrigation fluid to exit from a first said apparatus through said exit port and through said connecting conduit and into an entrance port of another said apparatus in order to connect said apparatuses in a series, and said exit port being capable of being plugged by an exit port cap so that said exit port of the last apparatus of said series may be plugged in order to prevent water loss through said exit port; a plurality of pressure compensating emitters, said pressure compensating emitters being mounted in the outer wall of said tube such that pressurized fluid within said hollow interior of said tube may be emitted through said pressure compensating emitters into the ground surrounding said tube in a measured fashion; an end plug; said end plug closing off the bottom of said tube; an internal reservoir; said internal reservoir comprising the space in the bottom portion of the hollow interior of the tube between the bottommost pressure compensating emitter and said end plug, said interior reservoir being capable of receiving fertilizer, pesticide, fungicide, or other irrigation additive; and a removable vacuum release valve, said removable vacuum release valve depending from the top of said tube above the ground, said removable vacuum release valve being capable of allowing air to enter into said tube when said irrigation fluid is not under pressure, said removable vacuum release valve providing aeration while allowing air to enter into said tube, and said removable vacuum release valve being capable of being removed in order to allow for fertilizer, pesticide, fungicide, or other irrigation additive, to be added to said internal reservoir;
whereby said apparatus is buried substantially near each plant or tree to be irrigated such that said pressure compensating emitters are located substantially near the underground root zone of each said plant or tree to be irrigated; said connecting conduit is connected from said source to said entrance port of first said apparatus; if more than one of said apparatuses are being used in said series, another said connecting conduit is connected between the exit port of a previous said apparatus in said series to the entrance port of the next said apparatus in said series; said exit port of last said apparatus in said series is plugged with said exit port cap, and said irrigation fluid is delivered from said source to first said apparatus through said connecting conduit and, if more than one of said apparatuses are being used in said series, then to the next said apparatus in said series through the next said connecting conduit in order to irrigate each said plant or tree.

2. An apparatus for irrigation, said apparatus comprising: a tube, said tube comprising a rigid outer wall, which is suitable for burial underground and a hollow interior, which is capable of receiving pressurized irrigation fluid and which is surrounded by said rigid outer wall; an entrance port, said entrance port depending from said tube, said entrance port being suitable for connecting to a connecting conduit, such as a garden hose or a pipe, in order to allow irrigation fluid from a source to enter said tube through said entrance port; an exit port, said exit port depending from said tube, said exit port being suitable for connecting to a connecting conduit, such as a garden hose or a pipe, in order to allow excess irrigation fluid to exit from a first said apparatus through said exit port and through said connecting conduit and into an entrance port of another said apparatus in order to connect said apparatuses in a series, and said exit port being capable of being plugged by an exit port cap so that said exit port of the last apparatus of said series may be plugged in order to prevent water loss through said exit port; a plurality of free flow emitters, said free flow emitters being mounted in the outer wall of said tube such that pressurized fluid within said hollow interior of said tube may be emitted through said free flow emitters into the ground surrounding said tube; an end plug; said end plug closing off the bottom of said tube; an internal reservoir; said internal reservoir comprising the space in the bottom portion of the hollow interior of the tube between the bottommost pressure compensating emitter and said end plug, said interior reservoir being capable of receiving fertilizer, pesticide, fungicide, or other irrigation additive; and a removable vacuum release valve, said removable vacuum release valve depending from the top of said tube above the ground, said removable vacuum release valve being capable of allowing air to enter into said tube when said irrigation fluid is not under pressure, said removable vacuum release valve providing aeration while allowing air to enter into said tube, and said removable vacuum release valve being capable of being removed in order to allow for fertilizer, pesticide, fungicide, or other irrigation additive, to be added to said internal reservoir; whereby said apparatus is buried substantially near each plant or tree to be irrigated such that said free flow emitters are located substantially near the underground root zone of each said plant or tree to be irrigated; said connecting conduit is connected from said source to said entrance port of first said apparatus; if more than one of said apparatuses are being used in said series, another said connecting conduit is connected between the exit port of a previous said apparatus in said series to the entrance port of the next said apparatus in said series; said exit port of last said apparatus in said series is plugged with said exit port cap, and said irrigation fluid is delivered from said source to first said apparatus through said connecting conduit and, if more than one of said apparatuses are being used in said series, then to the next said apparatus in said series through the next said connecting conduit in order to irrigate each said plant or tree.

3. The irrigation apparatus of claim 1, wherein said removable vacuum release valve is replaced by a pressure compensating emitter in order to allow for simultaneous above-ground irrigation and below-ground irrigation.

4. The irrigation apparatus of claim 2, wherein said removable vacuum release valve is replaced by a free flow emitter in order to allow for simultaneous above-ground irrigation and below-ground irrigation.

5. The irrigation apparatus of claim 1, wherein said outer wall is semi-rigid.

6. The irrigation apparatus of claim 2, wherein said outer wall is semi-rigid.

7. The irrigation apparatus of claim 1, wherein a pressure regulator is installed in said connecting conduit between said source and first said apparatus.

8. The irrigation apparatus of claim 1, wherein a filter is installed in said connecting conduit between said source and first said apparatus.

9. The irrigation apparatus of claim 1, wherein a directional flow check valve is installed in said connecting conduit between said source and first said apparatus.

10. The irrigation apparatus of claim 2, wherein a pressure regulator is installed in said connecting conduit between said source and first said apparatus.

11. The irrigation apparatus of claim 2, wherein a filter is installed in said connecting conduit between said source and first said apparatus.

12. The irrigation apparatus of claim 2, wherein a directional flow check valve is installed in said connecting conduit between said source and first said apparatus.
